(19) United States
(12) Patent Application Publication
(10) Pub. No.: US 2021/0319383 A1
(43) Pub. Date: Oct. 14, 2021

(54) SYSTEMS AND METHODS FOR ALLOCATING OBJECTS

(71) Applicant: BUYFAIR (HOLDINGS) LIMITED, Greater London (GB)

(72) Inventors: Joshua INGHAM, Greater London (GB); Oliver PLUCKROSE, Greater London (GB); Damon WESTBURY, Greater London (GB); Dominic SPEELMAN, Greater London (GB); Guy TRITTON, Greater London (GB)

(73) Assignee: BUYFAIR (HOLDINGS) LIMITED, Greater London (GB)

(21) Appl. No.: 17/268,866

(22) PCT Filed: Aug. 14, 2019
(86) PCT No.: PCT/GB2019/052285

§ 371 Date: Feb. 16, 2021

(30) Foreign Application Priority Data
Aug. 16, 2018 (GB) 1813375.1

(51) Int. Cl. G06Q 10/06; G06Q 10/04

(52) U.S. Cl. CPC G06Q 10/06313; G06Q 30/08; G06Q 10/06315; G06Q 10/04

(57) ABSTRACT

Systems and methods for allocating objects are provided. In these systems and methods a request is received from a plurality of users. Each request has a predefined format comprising a minimum number of requested objects, a maximum number of requested objects and a price offered per object. Based on each of the received requests, an optimised allocation of at least some of the plurality of objects is calculated. The calculation step is arranged such that it occurs within a predefined time period and optimises the total allocated number of the plurality of objects and/or the total price for the plurality of objects.

The present disclosure relates to systems and methods for allocating a group of objects between a group of users. The present disclosure may be applied to an online auction website whereby a seller holding a large number of products wishes to sell its products to multiple buyers in a manner that optimises allocation of the products and the financial return to the seller.

### BACKGROUND

It is common for manufacturers and wholesalers to hold large quantities of stock which is difficult to sell. This may be end-of-season stock or stock which has fallen out of fashion. The manufacturer or wholesaler will often seek to sell such surplus or remainder stock at a substantial discount to a discount retailer or buyer. The manufacturer or wholesaler will not think to divide up the stock and sell the divided lots to multiple buyers because (i) it is difficult to find (particularly at short notice) multiple buyers; (ii) reaching agreement on price with multiple buyers takes time and effort; (iii) there is often a need to sell the stock quickly (i.e. so that the sale is included in a particular financial year); (iv) there may still be stock left over if the stock is split between multiple buyers.

Accordingly, the practice has developed whereby manufacturers or wholesalers sell all of their surplus or unwanted stock at a heavy discount to known discount retailers or buyers. The above method of selling means that smaller and medium size retailers who may not want to buy large quantities of surplus stock do not have an opportunity to offer to buy some of the stock at a price higher (often much higher) than the price offered by the discount retailer or buyer. If in aggregate, there is sufficient demand from such small and medium sized retailer to buy all of the surplus or remainder stock at these higher prices, the current method of selling all the stock to one discounter retailer fails to maximise the return to the manufacturer or wholesaler.

Furthermore, it is well known that there are online auction sites whereby multiple bids are made for a quantity of products offered by a seller with the highest offer at the expiry of a fixed period becoming the winning bid. These online auction sites do not allow one seller of a fixed quantity of products to subdivide the quantity of products to multiple buyers to ensure maximum return to the seller. One reason for these sites not offering such a method is that it would require a brute force comparison of a large number of different bids with different variables (such as requested quantities, price per object). For large quantities of stock this brute force method is not practicable or feasible—particularly if a solution to the brute force method is required in real time. Another reason is that online auction sites reflect the practices in physical auction rooms where buyers do not bid for subdivided quantities of a lot.

The main problem inherent in a brute force comparison of bids is that, as more buyers make bids, they increase the number of ways of allocating the products by at least a factor of 2. A brute force algorithm needs to check to see if sale value is maximised by adding or removing each buyer in combination. For one buyer the solution is simple, their total price (bid value multiplied by allocated objects) is larger than 0, so they win. For two buyers the solution is again quite simple, but instead of checking two values, the algorithm must now check four: no buyers, buyer 1 only, buyer 2 only, or some combination of buyer 1 and buyer 2. Add another buyer, and there become eight possible combinations to check. With four buyers, there are sixteen possible combinations to check. The brute force algorithm thus has to check 2 to the power of n (2\hat{ }n) combinations, where n is the number of buyers. For 25 buyers, a brute force algorithm that does nothing but choose one combination at random would require significant computing resources to even output a result in 30 seconds.

There is accordingly a need for a system that optimises both the allocation of products and the return to the seller selling surplus or unwanted stock to multiple retailer or buyers, in comparison to just selling all of the products at a substantially discounted price to one buyer.

### SUMMARY OF THE DISCLOSURE

The present disclosure seeks to optimise the maximum return and/or the total number of objects allocated in a multiple object to multiple user distribution system. The present disclosure is most applicable to the distribution of large numbers of objects between a large number of users wishing to purchase some or all of the available objects. The present disclosure also seeks to provide an auction system whereby a seller of a group of objects (and typically a very large number of objects), offers the objects for sale at auction (which in the prior art would be sold as a single group—called a “lot”) in sub-lots to multiple bidders in a manner that optimises both the allocation of the objects and the financial return to the seller. Typically, this will be through a website or other electronic trading platform.

The present disclosure makes use of a pre-defined request format comprising a minimum number of requested objects, a maximum number of requested objects and a price per object. There is a real complexity if buyers have minimum and maximum requirements as to products when combined with a particular price. To deal with this complexity, the present disclosure uses an iterative optimisation algorithm, which makes use of the pre-defined request format, to provide real-time computation of this optimised distribution without resorting to a pure brute-force comparison of every permutation of request from each user. The present disclosure provides a far more computationally efficient method of performing such calculations, which reduces the processing requirements of systems employing such methods.

The present disclosure provides systems and methods which have the following advantages (i) a seller can sell sub-lots of objects to multiple buyers in a manner that maximises the financial return to the seller; (ii) buyers are given real-time feedback via an interface as whether their offer would lead to them being successful in getting the objects that they want in the quantities that they want and at the price that they have bid; (iii) buyers who set out their minimum and maximum of required objects at the offer price that they want, can see in real time the quantity (necessarily lying in their requested range of products) that they will receive if there were no further bids; (iv) the buyer can see in real time the number of objects they will receive for a given set of variables (e.g. minimum quantity, maximum quantity, price) in a “virtual” (test) bid (assuming no further bids) before making a binding “live” bid in order for them to adjust said variables so that they make a bid which is most advantageous to the buyer.

One of the technical effects of the present disclosure is to enable real-time feedback to be provided to a bidder upon placement of a virtual bid or a live bid for a number of objects. The real-time feedback enables a user to understand how many objects they will receive if the auction was closed after making the virtual or live bid. This enables a bidder to try out several bids with differing variables of minimum number of requested objects, maximum number of maximum objects and price per object. These bids may be submitted as “live” bids or may be entered in a virtual (test) environment to determine what is likely to be the best bid to meet the bidder's commercial wishes. Alternatively, if the bidder makes a live bid, the bidder will see how many objects they will get for that bid (assuming the auction was closed) and may choose to offer a revised bid.

In a first aspect, the present disclosure provides, a method for allocating a plurality of objects between a plurality of users, the method comprising: receiving a request from each of the plurality of users, each request comprising one or more parameters; calculating, based on each of the received requests, an allocated number of the plurality of objects for each user, wherein the calculation step includes use of an optimisation process to optimise the allocation of the plurality of objects based on the one or more parameters of each request.

In a second aspect, the present disclosure provides, one or more non-transitory computer readable media storing computer readable instructions which, when executed, cause a system to perform a method of: receiving a request from each of the plurality of users, each request comprising one or more parameters; calculating, based on each of the received requests, an allocated number of the plurality of objects for each user, wherein the calculation step includes use of an optimisation process to optimise the allocation of the plurality of objects based on the one or more parameters of each request.

In a third aspect, the present disclosure provides a system, comprising: a processor; and memory storing computer readable instructions which, when executed, cause the system to perform a method of: receiving a request from each of the plurality of users, each request comprising one or more parameters; calculating, based on each of the received requests, an allocated number of the plurality of objects for each user, wherein the calculation step includes use of an optimisation process to optimise the allocation of the plurality of objects based on the one or more parameters of each request.

Further features of the invention are defined in the appended dependent claims.

### BRIEF DESCRIPTION OF THE DRAWINGS

By way of example only, the present invention will now be described with reference to the drawings, in which:

FIG. 1 shows a flow chart showing a method in accordance with a first embodiment of the present disclosure;

FIG. 2 is a flow-chart showing a method in accordance with an embodiment of the present disclosure;

FIGS. 3a to 3c illustrate an example calculation in accordance with an embodiment of the present disclosure;

FIGS. 4a to 4b illustrate an example calculation in accordance with an embodiment of the present disclosure;

FIG. 5 is a flow-chart showing a method in accordance with an embodiment of the present disclosure;

FIGS. 6a to 6d illustrate an example calculation in accordance with an embodiment of the present disclosure;

FIGS. 7a to 7d illustrate an example calculation in accordance with an embodiment of the present disclosure;

FIG. 8 shows a system in accordance with an embodiment of the present disclosure;

FIG. 9 shows a system in accordance with an embodiment of the present disclosure; and

FIG. 10 shows a representation of a graphical user interface in accordance with an embodiment of the present disclosure.

### DETAILED DESCRIPTION OF PREFERRED EMBODIMENTS

### Objects

The present disclosure describes systems and methods for allocating a group of objects between a group of users. The objects described in this disclosure may be, for example, leftover stock (such as clothes, food or the like). In this case the person may wish to dispose, sell or giveaway all of the leftover stock to clear their warehouse. Alternatively, the person may have a large amount of cargo (such as new cars, foodstuffs, raw material and the like) for distribution and wishes to allocate the cargo between a variety of shipping methods or shipping containers.

However, the objects need not be physical items. The objects may also be, for example, electronic vouchers, cryptographic currencies, gaming vouchers or tokens.

Moreover, the objects may relate to the provision of a service. For example, a consultant may decide to offer 1000 hours of his time and wishes to optimise the allocation of this time between multiple users whilst ensuring a maximal return for the 1000 hours. In this service example, the object is consultancy hours. In the following, the method will be exemplified as a “product selling scenario”, but the method applies equally to any form of distributing large numbers of objects between a large number of users/receivers/shipping options.

### Optimisation Process

A key aspect of the present disclosure is the use of an optimisation process to optimise the allocation of a plurality of objects offered by a seller between a plurality of buyers in a manner that meets an objective. e.g. to maximise the financial return to the seller (giving a MaxReturn). The objective could however be any other suitable objective, such as to optimise the maximum number of objects sold (MaxObj)). To achieve this objective, the optimisation process must take into account the variables associated with each request (e.g. the minimum number of objects required (MinObj), the maximum number of objects required (MaxObj), price (P)). Given that an object cannot be subdivided, the parameter MinObj and MaxObj must be integers. Other parameters, such as P do not necessarily need to be integers. The optimisation process will determine how many of the objects will be assigned to each bidder (within the defined constraints) in order to reach the objective (normally maximum financial return to the seller).

Furthermore, the optimisation process used must be one that, given a complex environment of many buyers, provides an optimal allocation of the available objects between the available buyers. This optimal allocation must be provided in a meaningful time (such as real-time or near real-time), so that the feedback may be provided to each buyer near instantaneously or sufficiently quick so that the buyer does not perceive there to be a bug, an error or a fault in the system, or otherwise loses interest in the process.

A known optimisation process that would meet the above requirements is Mixed Integer Linear Programming (MLP). This is a branch of mathematics and programming known in the prior art. Other optimisation processes could be used. By encoding an MLP optimisation process into the code of an electronic trading platform whereby the objective is defined (e.g. MaxReturn) and the input is a set of values representing input constraints that each buyer has provided to the platform (eg Quantity Required, MinObj, MaxObj, Price etc), the seller will receive a maximum financial return and the bidder (prospective buyer) will have feedback within an acceptable real-time period as to whether their request is wholly or partially successful if the auction would end after that bid. Similarly, if the request is a virtual bid, the seller will have feedback as to whether the request would be wholly or partially successful if placed as a live bid (again, if the auction ended after that bid). Instead of coding, the programmer could use third party bespoke code which uses MLP such as Microsoft® Solver Foundation or Gurobi® (Gurobi Optimiser).

An example of how MLP can work is set out below. In this example, the seller has 200 objects to sell and there are 5 requests which each have a price (Price) per object and the quantity of objects required (Quantity).

TABLE ONE

| | | | Financial |
|---|---|---|---|
| Request | Price | Quantity | Return |
| 1 | 2 | 40 | 80 |
| 2 | 1.75 | 80 | 140 |
| 3 | 1.66 | 60 | 100 |
| 4 | 1.6 | 100 | 160 |
| 5 | 1.5 | 120 | 180 |

In the above example, the MLP process will select Requests 1, 3 and 4 as giving the greatest financial return (being 340). It will reject other combinations (e.g. Request 2 and 5) as the financial return (being 320) is less. Moreover, it will be appreciated that merely starting with the request with the highest price and working downwards does not work either. If one were to do that, Requests 1, 2 and 3 would be selected to give an aggregate financial return of 320. Request 4 would not be selected as once Requests 1, 2 and 3 are selected, this leaves 20 objects remaining but Request 4 requires 100. The above is a simple example. However, it will be appreciated that where there are a very large number of requests, a brute force approach to solving such a problem quickly becomes computationally inefficient.

A known optimisation process, such as a Mixed Integer Linear programming process (MLP), may be used to quickly process a large number of requests in order to optimally allocate a plurality of objects between the users. A single MLP process (or any other suitable optimisation process) takes a series of input variables for each request for an available resource and calculates which variable, or combination of variables, should optimally be assigned some or all of the available resource. In other words, each MLP process considers all available requests and calculates which request, or combination of requests, should be allocated some or all of the available objects in order to satisfy the objective.

### Ranges

The applicant has also had the insight that an objective (e.g. MaxReturn) is more likely to be achievable if the number of allowable permutations that provide possible solutions is greater rather than smaller. Thus the applicant has recognised that the objective of maximum financial return to the seller is more likely to be achieved if in a request, the requester can set out a range for a particular variable rather than merely assign it one value. For instance, a requester may wish to stipulate that the number of objects that it requires (O) should lie in a range between a maximum quantity (MaxObj) to a minimum quantity (MinObj). Moreover, this accords with commercial reality. Often, an undertaking will not require a specific quantity of objects but will be content with acquiring any number of objects that fall within a range. For instance, a retail buyer may require between 100 and 200 chairs of a particular style and also realise that in stipulating a range, there is a better prospect of a successful request.

Optimisation processes such as MLP work with a single value for each variable. Thus, in Table One, for each request, the variables Price and Quantity have a single value. In particular, commercially available code for running optimisation process, like that provided by the Microsoft Solver Foundation®, work in such a manner.

Accordingly, it is necessary to come up with a new iterative process that can deal with a range for a particular variable.

It might be thought that having a range simplifies the problem. In some cases, it does. For instance, if there are a plurality of requests which stipulate price and a maximum required quantity without any minimum, solving the problem is fairly trivial. An iterative process that would work is one that starts with the request with the highest price and determines whether the maximum is less than or equal to the available objects. If such a condition is satisfied, it allocates the maximum requested objects, reduces the number of available objects by this number and then repeats the process for the request with the second highest price and so on until the maximum request of the nth request (for the nth highest price) is greater than the number of available objects, and then for this request, allocate the remaining available objects to that request and the process is then terminated. This is called here the “cascade” approach.

However, the cascade approach does not work in more complex environments. In particular, it does not work when (i) the bidder stipulates a minimum number (MinObj) or (ii) the bidder stipulates a fixed quantity of objects required (i.e. MaxObj=MinObj). It will be rare that a bidder will want to stipulate a maximum without also stipulating a minimum.

For instance, in a situation whereby there are 1000 objects to sell and Buyer 1 only wants 10 objects at £6 and Buyer 2 only wants 1000 objects at £5, then the above “cascade” approach would allocate Buyer 1 with 10 objects and Buyer 2 with nothing (as the available objects would be 990 which is less than 1000 that Buyer 2 wants) with a total financial return to the seller of £60. With a large number of available objects and a large number of requests, each with different values to MinObj, MaxObj and Price, the cascade approach does not work and a brute force approach which considers every permutation is computationally inefficient and does not permit real time feedback.

Iterative Process Using Optimisation Process for Requests where Value of Variable Lies in a Range

When using a range, an iterative process can be introduced in which the value of one or more input variables is successively reduced within its range, and additional optimisation processes are run based on a) the reduced input variables, and b) the originally available resources minus those resources previously allocated. This improved method provides a computationally efficient method of optimising the allocation of these resources and will be described in detail below.

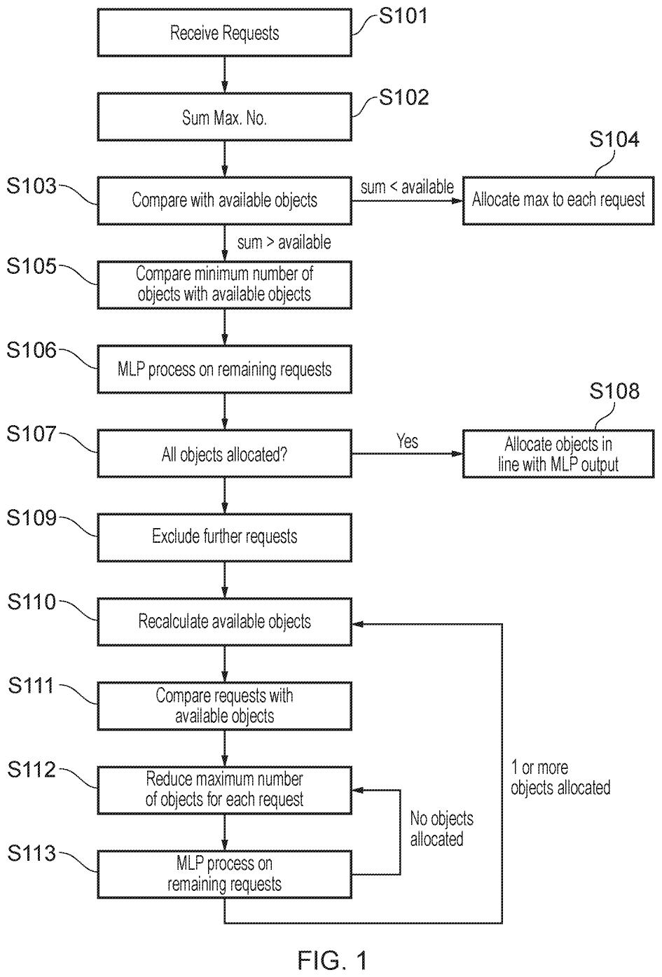

A method in accordance with an embodiment of the disclosure will now be described in relation to FIG. 1. FIG. 1 shows a flow chart of this method.

At step S101, a plurality of requests are received from a plurality of users. At the start, it is presumed that one request will be received per user. However, each user may submit multiple requests, and at later stages of the method, they may be encouraged to submit additional requests. Each request comprises at least: 1) a minimum number of objects of the plurality of objects that would be acceptable to the user, 2) a maximum number of objects of the plurality of objects that would be acceptable to the user, 3) and a price per object. For some requests, the maximum and minimum number of objects may be the same.

At step S102, the maximum number of objects of each request are summed together. At step S103, this summed maximum number of objects is then compared with the available number of objects to be allocated. In situations where this summed maximum number of objects is less than the available number of objects, the optimal solution is simple, each request is allocated, at step S104, their maximum requested number of objects. In this scenario, allocating the maximum to every request ensures the maximum possible number of objects is allocated for the maximum total financial return to the seller.

However, if the summed maximum number of objects is more than the available number of objects, there is no trivial solution as to how to allocate which objects to which requests. The brute force approach of calculating every possible permutation for every request having at least three constraints (MaxObj, MinObj, Price) quickly becomes computationally intensive. Even with a relatively small number of requests, finding an optimal solution can no longer be achieved in near-real time by commonly available computer systems. Instead of a brute force method, the present example method performs the following steps.

At step S105, the minimum number of objects of each request is compared to the number of available objects. Any request which has a minimum number of objects which is greater than the available number of objects is excluded from any further calculation. This is because, even if all of the available objects were allocated to any such request, the minimum number of objects limitation in the request would not be satisfied. Excluding such requests simplifies the further calculations.

At step S106, the maximum number of objects of each remaining request is then fed into an optimisation process, such as a Mixed Integer Linear Programming (MLP) process, which has been described above. This optimisation process takes as values for input variables for each request, the maximum number of objects required (MaxObj) and price (Price) and determines which request or combination of requests provides the optimal allocation of the available objects in a manner which meets the stated objective (e.g. maximising the total financial return to the seller). Any suitable optimisation process may be used—MLP process is but one example.

At step S107, it is determined whether the MLP process has allocated all of the available objects during the MLP process. If the output of the MLP process S106 has allocated all available objects, the available objects are allocated in line with the output of the MLP process and the method ends (s108). However, after this MLP process S106, in all but trivial cases, the number of available objects will not have been allocated. Therefore, the method continues to perform the following steps.

In addition to the requests previously excluded at s105, at step S109, any request which was allocated its maximum number of objects in the initial process is now excluded from any further calculation.

Then, at step S110, the number of available objects is recalculated. This recalculation S110 may be a simple subtraction of the number of allocated objects from the first MLP process S106 from the original number of available objects. For example, if there were 1000 objects originally available and 700 objects were allocated in the first round, then the number of available objects for the second round would be 300 objects.

At step S111, the minimum number of objects of each remaining (i.e. non-excluded) request is compared with the recalculated number of available objects. Any request which has a minimum number of objects which is greater than the recalculated available number of objects is also excluded from any further calculation.

Next, at step S112, the maximum number of objects of each remaining request is compared to the recalculated number of available objects. Each request with a maximum number of objects which is higher than the recalculated number of available objects has their maximum number of objects reduced by one (a reduction by one is used in the current example but a reduction by more than one could be used in the current method). Any request whose reduced maximum number of objects is lower than the request's minimum number of objects is then excluded from further calculation. However, at this stage, requests with a reduced maximum higher than the recalculated number of available objects are still included in the calculation (although they will not be allocated any objects in the next iteration, they may be allocated objects in a further iteration if their maximum is lowered sufficiently).

At step S113, a second MLP process is performed on all of the remaining requests to attempt to allocate more of the remaining objects. There are two possible outcomes of this second MLP process.

The first possible outcome is that no additional available objects are allocated in this second iteration. This will occur if for example, the reduced maximum number of objects of each request is higher than the recalculated number of available objects. In this case, the recalculated number of available objects is not changed (as no objects were allocated). However, each remaining request with a maximum number of objects which is still higher than the recalculated number of available objects has their maximum number of objects reduced further by an additional one object (a reduction by one is used in the current example but a reduction by more than one could be used). I.e. step S112 is repeated. Any request whose further reduced maximum number of objects is now lower than the request's minimum number of objects is then excluded from further calculation. If all requests have been removed from the calculation then the process stops. Otherwise, a third MLP process, S113, is performed on all of the remaining requests to attempt to allocate more of the remaining objects. This process is repeated until one or more objects is allocated or all remaining requests have been removed from the calculation.

The second possible outcome from the second MLP process (as with any of the further iterated processes) is that one or more objects is allocated during said process. After an iteration with an allocation, the number of available objects is again recalculated, S110, by subtracting the number of allocated objects from the available objects to find the remaining number of available objects. Steps S111, S112 and S113 are then repeated in an attempt to allocate further objects

The above described iterative processes are then repeated until either all requests have been removed from the calculation or until there are no available objects leftover. At this point, the process ends as a first solution to this method has been reached which optimises the allocation of objects to the highest price request has been achieved.

When a further request is received the entire process (S102 to S113) is re-run using the original number of available objects. I.e. the previously allocated numbers of objects are removed and a new solution is sought based on the original requests, the further request and the original number of available objects.

Upon completion of the method above described method, the source of each request may be sent a summary of the allocation of objects. This summary may illustrate the number of objects allocated to the request based on its parameters. This summary may also provide a summary of the allocation of objects across all requests. Moreover, the summary may provide an indication of how many additional objects may be allocated to a user in one or more the following cases: the maximum number of objects is increased or decreased, the minimum number of objects is increased or decreased, the price per object is increased or decreased. One advantage of the presently described method is that recalculating the outcome based on a change in any of these variables can be done in near real-time, enabling the user to be provided with real-time feedback, which is particularly useful when the user wishes to try out a variety of different “virtual” requests before placing a live request.

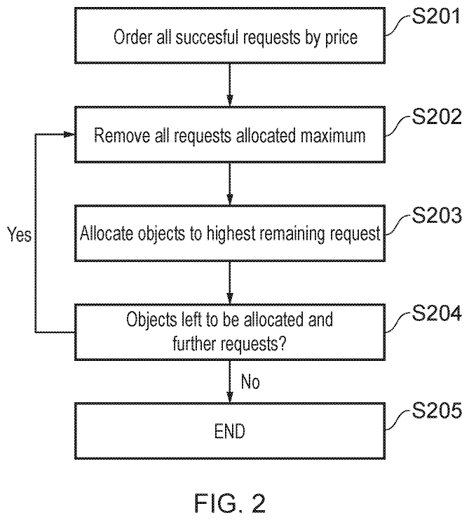

FIG. 2 is a flow chart illustrating an extension to the method described in relation to FIG. 1. The steps of the extended method may be used if, after the process described in FIG. 1 has finished, there are still a number of available objects that have not been allocated. In this situation, at step S201, all of the successful requests (i.e. requests which have had at least some objects allocated to them) are ordered by decreasing object price.

At step S202, successful requests which have been allocated their maximum number of objects are removed (this also may occur before the ordering step). Then these remaining ordered requests (which have each received less than their maximum number of objects) are allocated additional available objects up to their maximum number of objects, starting from the ordered request offering the highest object price. Therefore, at step S203, the highest price of remaining request is allocated more objects until either the request's maximum number of objects is reached or there are no further objects to allocate.

At step S204, a check is made to see if there is both a) additional remaining unallocated objects and b) successful requests (i.e. those that requests that have previously been allocated one or more objects), that are still in the calculation. If yes is answered to both questions, the method repeats steps S202, S203 and S204, until no is answered for one or both of these questions. Once a “no” is answered, the process ends at step S205. This method ensures successively priced requests are successively filled up until either there are no remaining objects to allocate or all requests are at their maximum.

As with the method described with reference to FIG. 1, when a new request is received, all of the original available objects are deallocated and the entire above process may be repeated once the method of FIG. 1 has completed. This ensures that an optimal solution is arrived at which takes into account the new request.

An advantage of the above described processes is that they provide an optimal (or close to optimal) solution to the problem of how to maximise both the total number of objects allocated at the best possible total price for the allocated objects. Additionally, the above described methods are much more computationally efficient than the prior art “brute force” approach. The above described methods are so improved that real-time or near real-time calculations can be performed for any given number of requests, allowing real-time (or near real-time) feedback to be provided to a user to inform them as to how their request has affected the current allocation of objects.

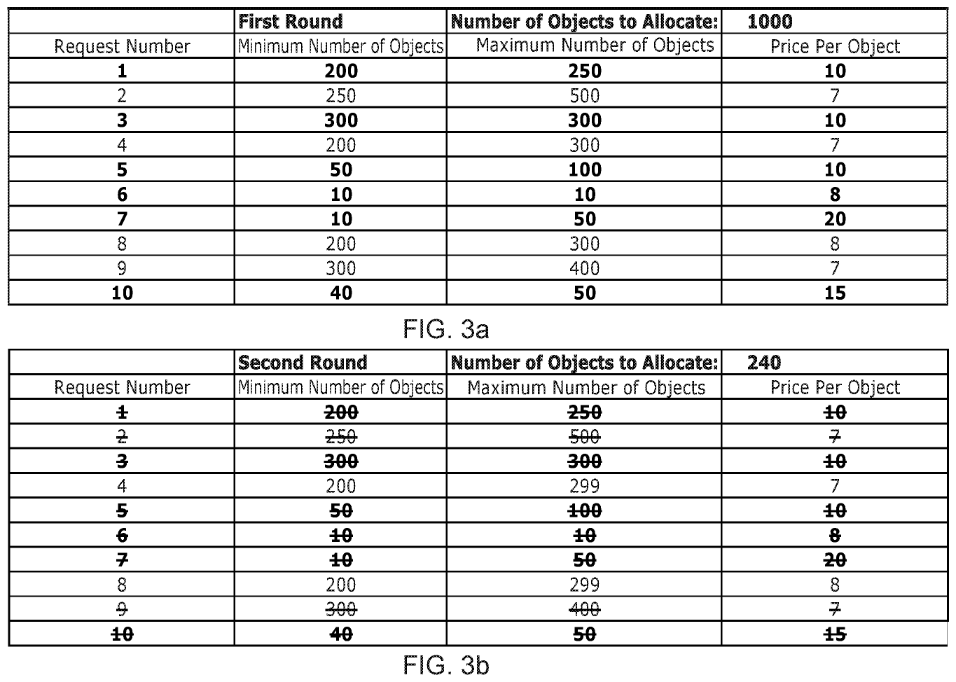

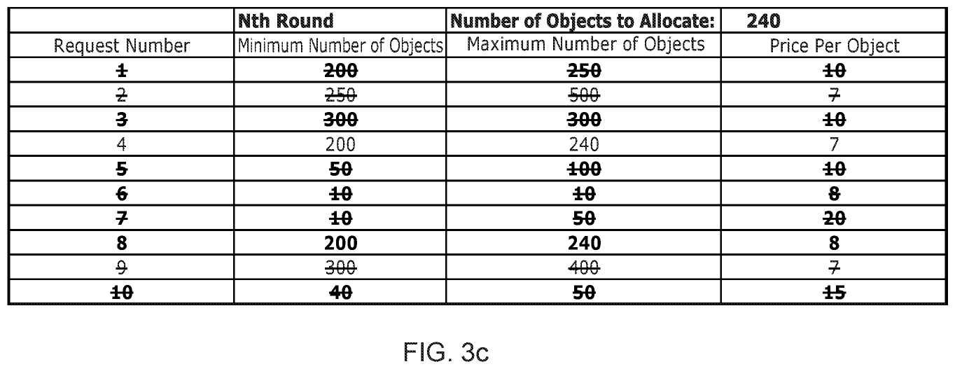

An example calculation, in accordance with the present disclosure will now be described with reference to FIGS. 3a to 3c. In this example calculation, there are 1000 objects to allocate. At the time this calculation is performed, 10 requests have been received. This calculation will have been run previously upon receipt of each request. Moreover, if further requests are received, this calculation will be performed again.

At the first step, the maximum number of objects for each request is summed. For the example shown in FIG. 3a, this sum totals 2260. Since the summed requested maximum number of objects is more than the 1000 available objects, it is not possible to simply allocate the maximum number of requested objects to each request.

The next step in the process is to remove any bids with a minimum number of objects that is more than the 1000 that can be provided. In the example shown in FIG. 3a, there are no such bids to be excluded. After this step, an optimisation algorithm is run on the remaining bids to see what is the optimum selection of requests to select that maximises the total price and total allocation of objects. This optimisation algorithm may be the MLP process described above. In FIG. 3a, the optimal output of this process is to select requests 1, 3, 5, 6, 7 and 10, as is highlighted in grey in FIG. 3a. These requests have been selected as they represent the combination of requests that maximise the financial return for allocating some of the objects. If the goal of the optimisation process was to maximise the number of objects allocated (rather than financial return), a different combination of objects may have been selected.

Selecting requests 1, 3, 5, 6, 7 and 10 allocates 760 of the available 1000 objects. An additional iteration must therefore be run if all of the objects are to be allocated, since 240 objects would otherwise be leftover. This second iteration is illustrated in FIG. 3b. In FIG. 3b the requests which have been previously allocated their maximum number of objects (requests 1, 3, 5, 6, 7 and 10) are excluded from the calculation, as shown by being stricken-through. Additionally, request 9 is excluded as its minimum number of requested objects (300) is less than the available remaining objects (240).

Next, the maximum number of objects of each remaining request (request 4 and 8) is reduced. In this case, both request 4 and 8 have their maximum number of objects reduced to 299. After this step, an optimisation algorithm is run on the remaining bids to see if any further objects can be allocated, and if so, what the optimal allocation is. In the example shown in FIG. 3b, no objects can be allocated based on the reduced maximum number of objects, as there are fewer objects to allocate than the reduced maximum number of objects.

This iterative process then repeats whilst there are still remaining requests with maximum number of objects higher than their minimum (and have not otherwise been excluded). FIG. 3c show this iteration after a further “n” iterations. In this case, a further 59 iterations has been performed such that the maximum number of objects of requests 4 and 8 has been reduced to 240. When the next optimisation algorithm is run, request 8 is allocated the remaining 240 objects, as shown in FIG. 3c. Since no further objects remain to be allocated, the process stops as the optimal solution has been arrived at.

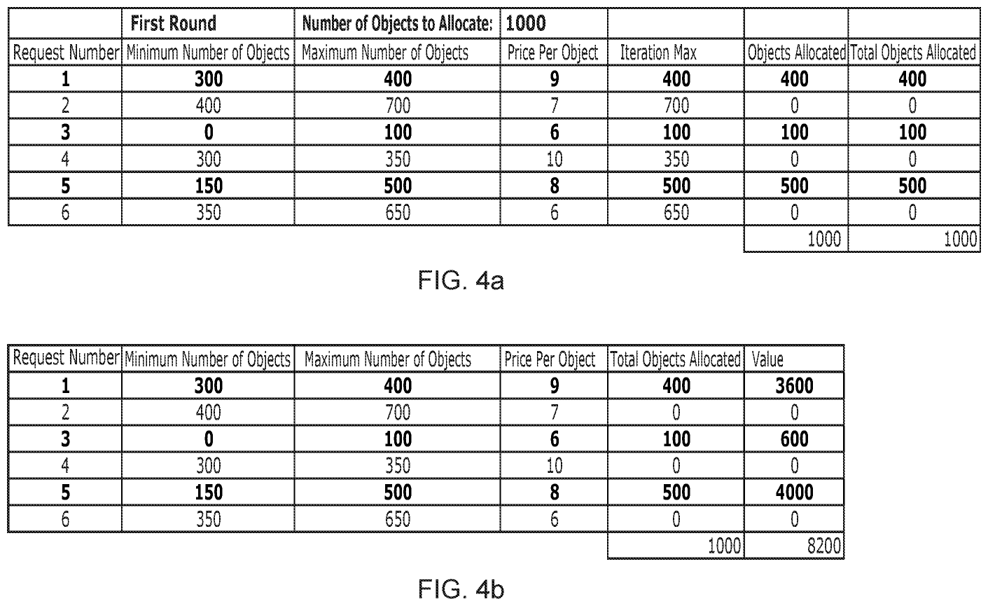

An additional example calculation, in accordance with an embodiment of the disclosure will now be described with reference to FIGS. 4a and 4b. In this example calculation, there are again 1000 objects to allocate. At the time this calculation is performed, 6 requests have been received. The above described methods have been performed to provide the iterations shown in FIGS. 4a and 4b.

FIG. 4a illustrates the results of the first iteration. In this simple example, in the first iteration, all 1000 available objects have been allocated. Request numbers 1, 3 and 5's maximum number of bids equal 1000 when summed together, meaning no further iterations are required to provide a solution. This particular combination of requests ensures that all objects have been allocated.

FIG. 4b illustrates the outcome of the optimisation process in more detail. FIG. 4b illustrates request numbers 1, 3 and 5 each being allocated their maximum number of bids, providing a total value of 8200. The solution arrived at by the present algorithm may be arrived at computationally very quickly, enabling each user submitting a request to be provided near real-time feedback on their request.

This selection of requests may initially seem counterintuitive as you may expect the optimal solution for achieving maximum financial return to include the requests offering the highest price per object. However, simple calculations can disprove this assumption. If request 4 (representing the highest price per object), request 1 (representing the second highest price per object) and request 3 (representing the only other request that could be allocated its maximum number of objects if requests 4 and 1 were given their maximum) were selected, then the financial return would only by 7800 ((350*10)+(400*9)+(100*6)). Instead, the selection of requests 1, 3 and 5 provides the optimal return (8200) based on each request's maximum number of objects.

It is important to emphasise that when using the process described herein in this application, that for each request, the MLP optimisation algorithm for that iteration can only take for each request one value (being MaxObj) rather than a range of values up to and including MaxObj. Thus, if one takes the approach whereby one starts with the highest price, then goes to the second highest price and then to the third highest price (i.e Request 4, Request 1 and then Request 5), the MaxObj values for these requests are 350, 400 and 500. The sum of these values exceed 1000. Hence, this solution would be rejected. As said above, whilst it might be thought that the “cascade” approach should be adopted whereby Request 4 is allocated its maximum (350), Request 1 is allocated its maximum (400) and then Request 5 is allocated 250 out of its maximum number (500), this approach does not work where each request stipulates a minimum required quantity of objects (MinObj) (whether MinObj is less than or the same as MaxObj i.e. the requester wants a fixed quantity).

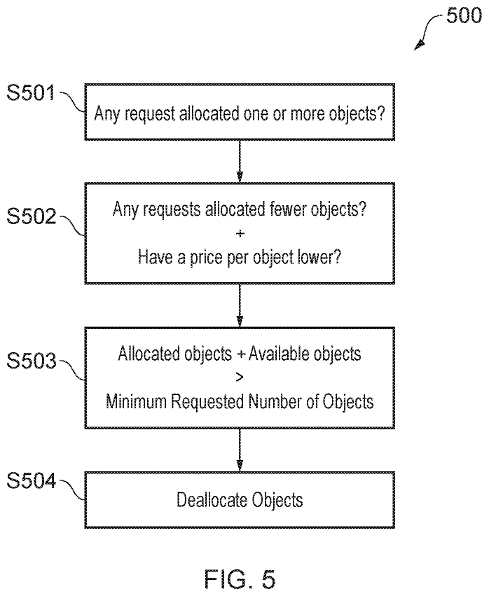

However, the solution shown in FIGS. 4a and 4b is not the optimal solution for total price achievable for the 1000 objects based on the ranges of each request. The optimal solution for total price would be request 4 receiving its maximum (350 objects at 10 per object), request 1 receiving its maximum (400 objects at 9 per object) and request 5 partially being fulfilled (250 objects at 8 per object). This improved outcome was not arrived at as each MLP process only takes into account the maximum number of objects of each request (or the reduced maximum number of objects in successive iterations). Additional method steps which allow this improved outcome to be arrived at are set out below in reference to FIG. 5.

FIG. 5 is a flow chart illustrating additional process steps which may be integrated into any of the previously described methods. It has been recognised that in certain arrangements of received requests, such as the example shown in FIGS. 4a and 4b, the previously described methods can allocate objects in a manner which is near-optimal but not fully optimal. To further illustrate this, an additional example of such a sub-optimal arrangement is described below.

In this additional sub-optimal example, there are initially 1000 objects available to be allocated. In a first iteration of the optimisation process, 970 of these objects are allocated between one or more requests (the details of these requests is unimportant for this example). In addition to the 970 objects, the remaining 30 of the available objects are allocated between three further requests, each request being allocated 10 of the 30 objects.

In this example, there is an additional request which a) offers more per object than some or all of the three requests allocated 10 objects and b) has a minimum of 30 objects or less (and therefore would have been satisfied by 30 objects). However, since in the first MLP process only the maximum number of objects of each request is considered, this request with a maximum of more than 30 objects was ignored for allocation of the 30 objects.

These four requests could be, for example:

Request 1—minimum 10 objects, maximum 40 objects, price per object: 9;
Request 2—minimum 10 objects, maximum 10 objects, price per object: 5;
Request 3—minimum 10 objects, maximum 10 objects, price per object: 5; and
Request 4—minimum 10 objects, maximum 10 objects, price per object: 5.

It is clear from this example that allocating the available 30 objects to request 1 (giving a return of 270) rather than splitting the objects between requests 2, 3, and 4 (giving a return of 150) results in a higher return for the seller. However, the previously described methods would not consider this as an option on the first pass, due to discounting any request whose maximum number of objects could not be satisfied by the available number of objects to allocate. In some circumstances, this sub-optimal allocation would be acceptable as it is close to the optimal allocation and computationally very efficient.

In order to overcome this sub-optimal allocation, within each iteration, before we check to see if there are any more objects left to allocate, we may check to see if any request with nothing allocated could be at least partially satisfied by taking objects from a combination of other buyers who have a requestprice that is lower than theirs, and if they can be, then the objects are deallocated from those lower price buyers.

In this example, there is a request which could be partially satisfied (30 objects would fall within the constraints of the minimum and maximum of request 1) by obtaining the objects of three other requests. To achieve this, requests 2 to 4 may have their objects deallocated. Then at the end of one of the iterative optimisation steps, when the process checks to see if we there are any objects still available to allocate, these 30 objects will be identified and re-allocated in subsequent iterations.

In order to identify requests to be de-allocated and enable the previously described methods to be further optimised, the following additional steps may be performed.

At step S501, the method checks each request to see if there are any that have not had any objects been allocated to them. This step may preferably by performed after each MLP process step (S106).

If one or more requests have not been allocated one or more objects, at step S502 it is checked if there are requests that have a) been allocated objects whose allocated number of objects is fewer than the request(s) identified in step S501's maximum number(s) of objects, and b) have a price per object that is lower than the request(s) identified in step S501's price per object.

If yes is answered to both checks in step S502, at step S503 a further check is performed to see if the total number of these objects allocated to the request(s) having a lower price per object, plus the number of objects otherwise available for allocation, equals a number greater than or equal to request(s) identified in step S501's minimum.

If yes is answered to the check at step S503, at step S504 the objects allocated to the requests identified in step S502 are deallocated from those requests. From this point, the method can proceed as described previously. That is, the method will check if there are any objects still available to allocate, and if so, iteratively reduce the maximum number of each request and run a further optimisation process. Continuing from the previous example, this means the process will iterate until the maximum number of objects of each request is reduced to 30, and then at this point the 30 objects will be allocated to the first request, and nothing to requests 2 to 4.

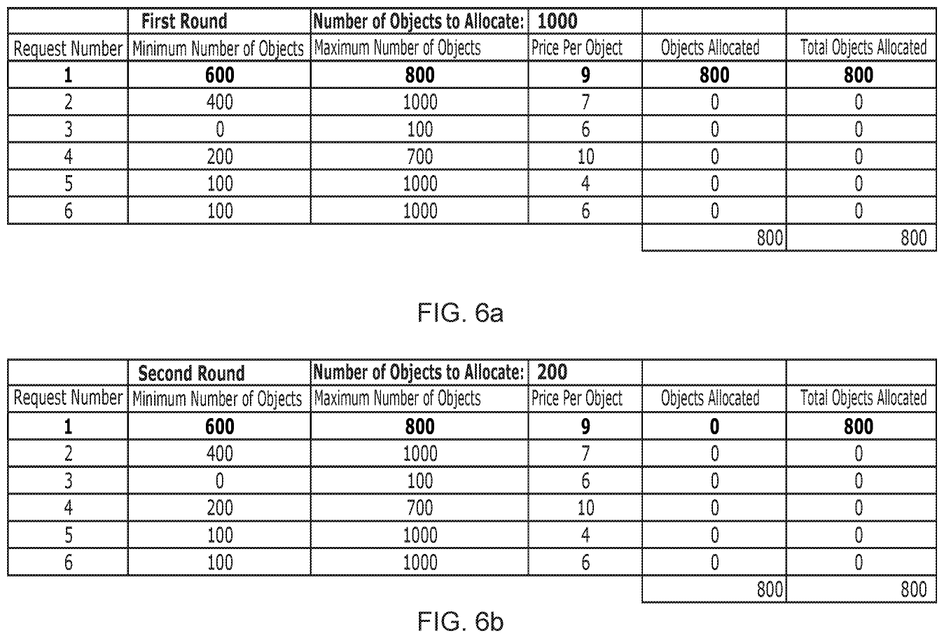

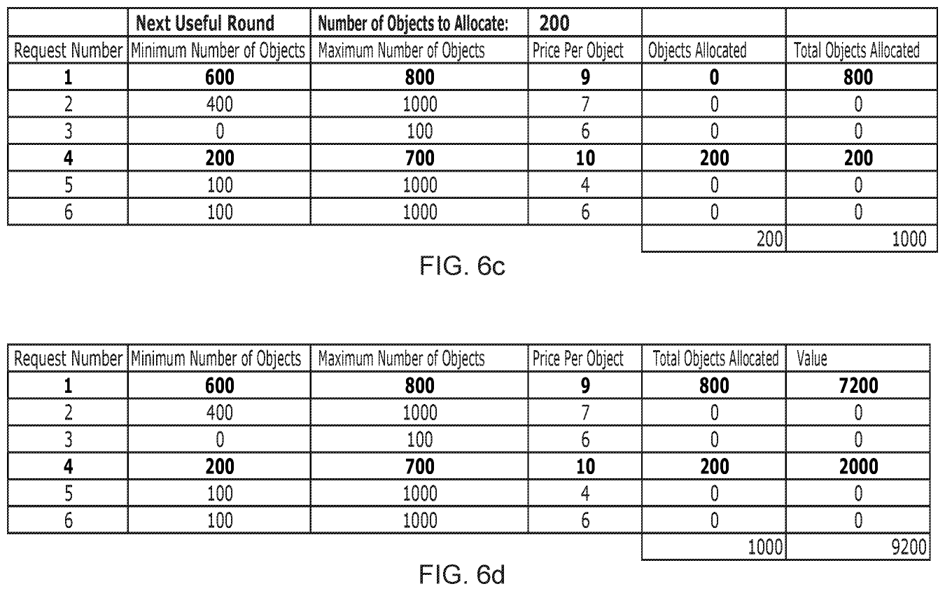

An additional example calculation in accordance with an embodiment of the disclosure, which incorporates the optimisation step described with reference to FIG. 5, will now be described with reference to FIGS. 6a to 6d. In this example calculation, there are again 1000 objects to allocate. At the time this calculation is performed, 6 requests have been received.

FIG. 6a illustrates the results of the first iteration. In this example, in the first iteration, 800 objects have been allocated. Request number 1 is allocated its maximum number of bids.

FIG. 6b illustrates the results of the second iteration. The second iteration is run in an attempt to allocate the 200 remaining objects. Each remaining request (2 to 6) has their maximum number of objects reduced by 1 (to 999, 99, 699, 999 and 999 respectively). Request 3, now having a maximum number of objects of 99, should have been allocated 99 objects (which may at the end of the process been increased to 100 in accordance with the method of FIG. 2). However, the additional method steps of FIG. 5 have caused those objects to be deallocated, since there are other remaining requests with a higher price per object that could be partly satisfied by 200 objects (request 4).

The iterative optimisation process continues until the next useful iteration, as shown in FIG. 6c. In FIG. 6c, the iteration has reduced the maximum number of objects of request 4 to “200”, meaning that it now can be allocated the remaining 200 objects. Further checks in accordance with FIG. 5 may be performed, but there are no unallocated requests with a higher price per object. Therefore, at this stage, the optimal outcome has been reached, as illustrated in FIG. 6d.

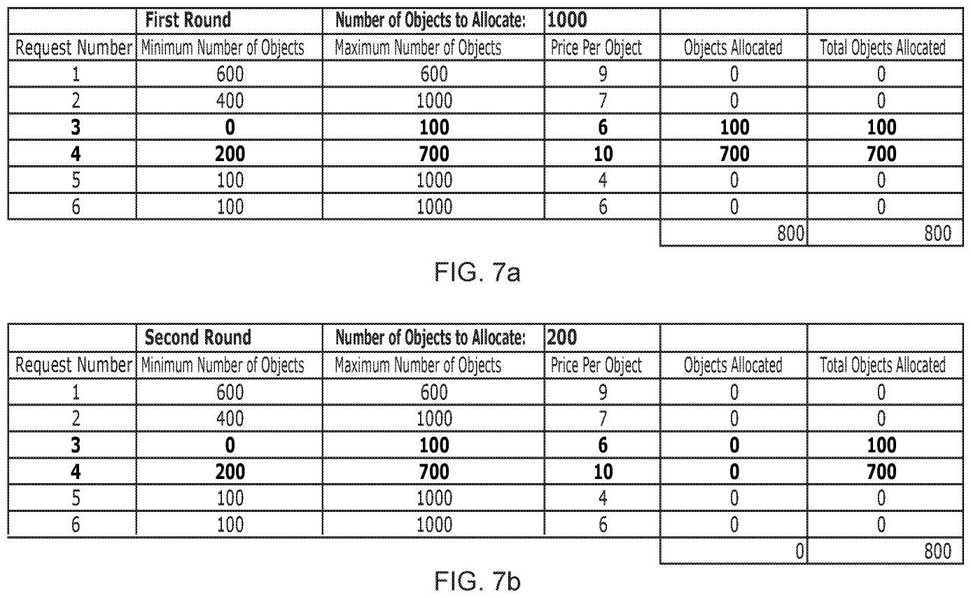

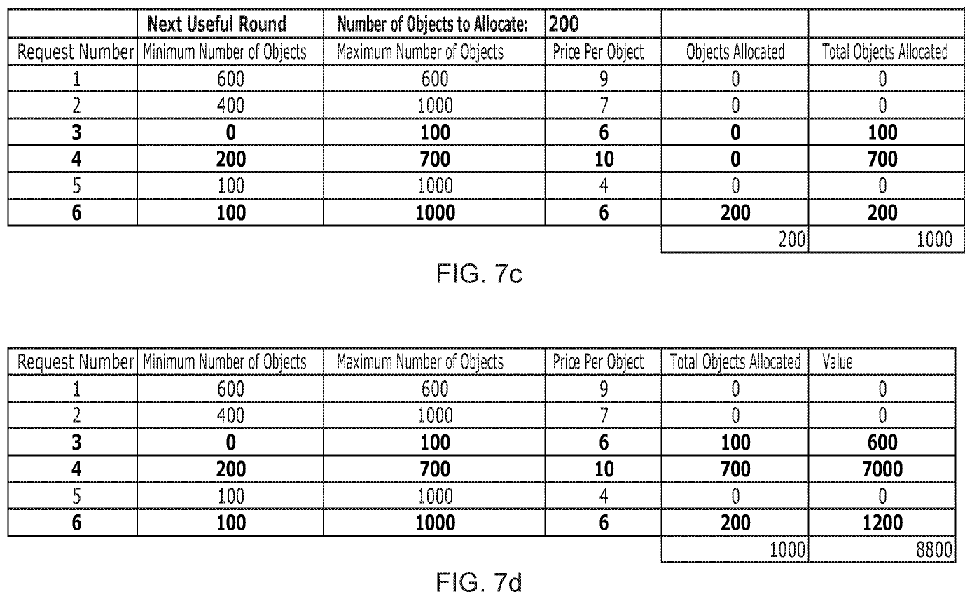

An additional example calculation, in accordance with an embodiment of the disclosure will now be described with reference to FIGS. 7a to 7d. In this example calculation, there are again 1000 objects to allocate. At the time this calculation is performed, 6 requests have been received.

FIG. 7a illustrates the results of the first iteration. In this example, in the first iteration, 800 objects have been allocated. Request numbers 3 and 4 have been allocated their respective maximum number of objects.

FIG. 7b illustrates the results of the second iteration. The second iteration is run in an attempt to allocate the 200 remaining objects. Each remaining request (1, 2, 5 and 6) has their maximum number of objects reduced by 1 (to 599, 999, 999 and 999 respectively). None of these requests are allocated any objects in this second iteration as each maximum is higher than the available 200 objects.

The iterative optimisation process continues until the next useful iteration, as shown in FIG. 7c. In FIG. 7c, the iteration has reduced the maximum number of objects of each of requests 1, 2, 5 and 6 to “200”. Requests 1 and 2 have been excluded as the reduced maximum is below each of their minimum requests. Therefore, in this iteration only requests 5 and 6 are reconsidered. Request 6 with its higher price per object is selected, and allocated the remaining 200 objects. Further checks in accordance with FIG. 5 may be performed, but there are no unallocated requests with a higher price per object. Therefore, at this stage, the optimal outcome has been reached, as illustrated in FIG. 7d.

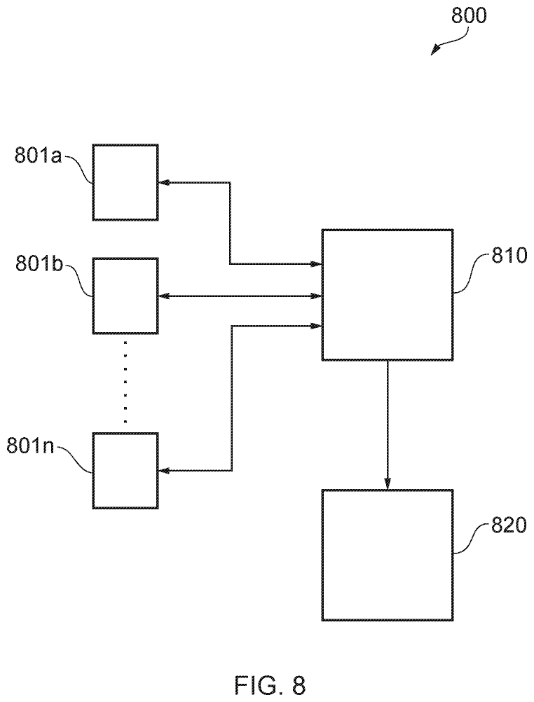

FIG. 8 illustrates a system 800 in accordance with an embodiment of the disclosure. FIG. 8 illustrates a plurality of user inputs 801a to 801n. In FIG. 8, three user inputs are illustrated. However, the system is arranged to be scaled such that any number of user inputs can interact with the system 800 at the same time. Each of the user inputs 801a to 801n is arranged to receive information about the number and type of objects available to be allocated. Moreover, each of the user inputs 801a to 801n is arranged to send requests comprising a minimum number of objects, a maximum number of objects and a price per object. User inputs 801a to 801n may be any type of suitable input, such as a computer, a mobile telephone, a laptop computer, a PDA and so forth.

User inputs 801a to 801n are arranged to receive inputs from their respective users, translates these inputs into the required request format, and send these requests to a request processing system 810. User inputs 801a to 801n are therefore in data communication with the request processing system 810. The interfaces may be connected to the request processing system 810 by any known method of connecting two devices, such as a Local Area Network, a cable data network, the Internet and/or a wireless data connection. The request processing system 810 may comprise one or more processors and memory (not shown) suitable for performing the methods described above. Therefore, the request processing system 810 is arranged to receive requests from the user inputs 801a to 801n 801a and perform the methods described above.

System 800 may further comprise a fulfilment system 820. The fulfilment system is arranged to receive data relating to successfully allocated requests from the request processing system 810 and thereafter fulfil said requests. These requests may be fulfilled by, for example, identifying the allocated objects and sending said objects to each user by postal delivery.

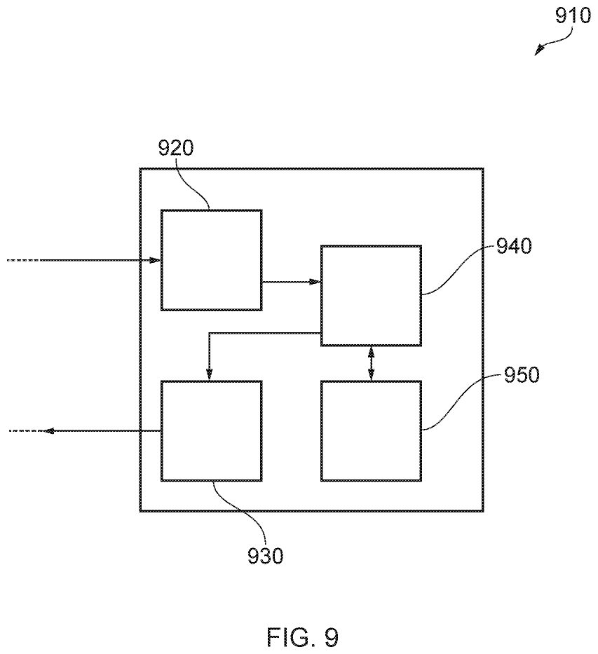

FIG. 9 is a schematic diagram showing a request processing system 810/910 in more detail. The request processing system is arranged to perform the methods described above. The request processing system 910 may form part of a standalone computer server or may be realised in a cloud-based computational system such as Amazon Web Services® or Microsoft Azure®. Request processing system 910 comprises an input 920 and an output 930. The input 920 is arranged to receive data from one or more user interfaces (not shown). The output is arrange to send data to one or more users interfaces (not shown) and one or more fulfilment systems (not shown).

The request processing system 910 also comprises one or more processors 940. Processor 940 may be a single core or a multi-core processor. Processor 940 is in operable communication with both the input 920 and the output 930. The processor is arranged to receive data from input 920 and sent data to output 930.

The request processing system 910 also comprises one or more memories 950. Memory 950 is in data communication with processor 940. Memory 950 may be any form of volatile or non-volatile memory. Memory 950 may be arranged to store computer readable instructions which, when executed by processor 940, cause the system 910 to perform any of the methods described herein. Memory 950 may also be arranged to store received requests, messages, or any other form of data described herein.

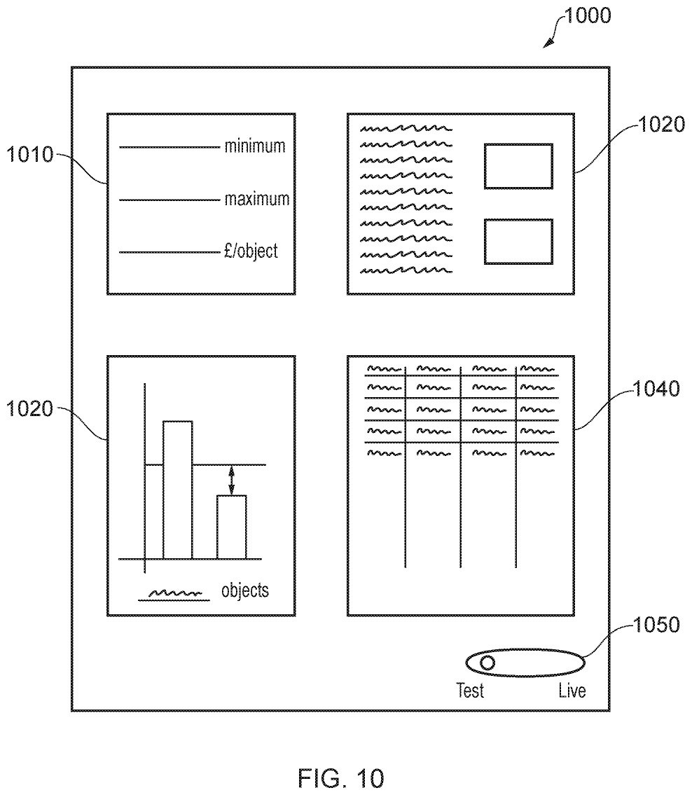

FIG. 10 is a representation of a graphical user interface 1000 in accordance with an embodiment of the disclosure. The graphical user interface 1000 comprises a user input section 1010. The user input section 1010 may display request information input by the user including, but not limited to, a minimum number of requested objects, a maximum number of requests objects and a price per object.

The user input section 1010 enables a user to place requests in accordance with the current disclosure.

The graphical user interface may also comprise an available object display section 1020. The available object display section 1020 can provide information to a user relating to the type, quantity, characteristics, weight, size or any other requirements, of currently available objects that the user may request on.

The graphical user interface 1000 may also comprise one or more outputs 1030, 1040 which enable the user to receive real-time or near real-time feedback relating to their request. The real-time feedback may be presented in a text format, graphically or in any other suitable form. The real-time feedback enables a user to understand how many objects they will receive if the auction was closed at the time of making the request. This enables a bidder to try out several successive requests with differing variables of minimum number of requested objects, maximum number of maximum objects and price per object.

The outputs 1030, 1040 may present a summary of the allocation of objects based on the inputted request. This summary may also provide a summary of the allocation of objects across all requests received from all users. Moreover, the summary may provide an indication of how many additional objects may be allocated to a user in one or more the following cases: the maximum number of objects is increased or decreased, the minimum number of objects is increased or decreased, the price per object is increased or decreased.

The outputs 1030, 1040 may also provide a user with an expected market price for an object (or multiple objects). The expected market price enables a user to make more informed requests. The expected market price may comprise a recommended retail price provided by a manufacturer or wholesaler, a current retail price, a previous sale price (from either the current system or from a competitor website), an appraised value or any other suitable expected market price.

The graphical user interface 1000 may also comprise an input 1050 which enables a user to move between a virtual (test) environment and a live environment. The test environment enables a user to input “requests” without them being considered real requests. This enables a user to try many different requests and see the current outcome of each request. If the user makes a request in the “live” environment, the user's request may be considered binding and they will see how many objects they will be allocated for that request.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

The above embodiments describe one way of implementing the present invention. It will be appreciated that modifications of the features of the above embodiments are possible within the scope of the independent claims. Features of the present invention are defined in the appended claims. While particular combinations of features have been presented in the claims, it will be appreciated that other combinations, such as those provided above, may be used.

1. A method for allocating a plurality of objects between a plurality of users, the method comprising:
receiving a request from each of the plurality of users, each request comprising one or more parameters;
calculating, based on each of the received requests, an allocated number of the plurality of objects for each user,
wherein the calculation step includes use of an optimisation process to optimise the allocation of the plurality of objects based on the one or more parameters of each request.

2. The method of claim 1, further comprising the steps of:
receiving a further request from one of the plurality of users; and
updating, based on each of the received requests and the further request, the allocated number of the plurality of objects for each user;
wherein the updating step occurs within a second predefined time period.

3. The method of claim 1, further comprising the step of:
sending, to each user, an indication of the number of objects allocated to them based on their request.

4. The method of claim 3, wherein the indication further comprises one or more of:
an indication of the allocation of the plurality of objects across the plurality of users; and
an indication of a predicted allocation of the plurality of objects based on a variation of one or more of the one or more parameters in the user's request.

5. The method of claim 1, wherein the calculation step occurs within a predefined time period.

6. The method of claim 3, wherein the indication is sent within a second predefined time period following receipt of a request.

7. The method of claim 1, further comprising the steps of:
identifying a user from the plurality of users who has been allocated zero objects; and
sending a notification to the identified user, the notification comprising an indication that zero objects have been allocated based on the user's request.

8. The method of claim 1, wherein the plurality of objects are allocated between more than one of the plurality of users.

9. The method of claim 1, wherein the one or more parameters comprise: a minimum number of objects, a maximum number of objects and a price per object.

10. The method of claim 9, wherein the optimisation process is arranged to optimise the total allocated number of the plurality of objects and/or total price of the plurality of objects.

11. The method of claim 9, further comprising the step of:
sending, to each user, an indication of the number of objects allocated to them based on their request, wherein the indication comprises one or more of:
an indication of the allocation of the plurality of objects based on a variation of a minimum number of objects in the user's request;
an indication of a predicted allocation of the plurality of objects based on a variation of a maximum number of objects in the user's request; and
an indication of a predicted allocation of the plurality of objects based on a variation of a price per object in the user's request.

12. The method of claim 9, wherein at least one of the plurality of objects are not allocated to any user in order to maximise the total price for the plurality of objects.

13. The method of claim 9, wherein the number of objects allocated to each user is one of: zero, a minimum number of objects in the user's request, a maximum number of objects in the user's request, or any number of objects in between a minimum number of objects and a maximum number of objects in the user's request.

14. The method of claim 9, wherein the calculation comprises an iterative process comprising the steps of:
allocating one or more of the plurality of users their requested maximum number of objects;
subtracting the plurality of objects allocated by the previous step from the original number of the plurality of objects; and
if one or more of the plurality of objects has not been allocated, allocating one or more of the plurality of users not previously allocated any objects, a number of the unallocated objects between their maximum number of objects and their minimum number of objects.

15. The method of claim 9, wherein the calculation step comprises:
summing the maximum number of objects from each of the received requests;
comparing the summed maximum number of objects with a total number of the plurality of objects; and
if the summed maximum number of objects is less than or equal to the total number of the plurality of objects, allocating each user their requested maximum number of objects.

16. The method of claim 15, wherein if the summed maximum number of objects is more than the number of the plurality objects, the calculation step further comprises:
allocating one or more of the plurality of users their requested maximum number of objects based on an optimisation model.

17. The method of claim 16, wherein if the number of objects allocated to the one or more of the plurality of users is less than the total number of the plurality objects, the calculation step further comprises:
excluding all requests which have previously been allocated at least one object;
reducing the maximum number of objects of at least one of the remaining requests by at least one object;
allocating one or more of the plurality of users their reduced maximum number of objects based on an optimisation model.

18. The method of claim 17, wherein if no objects can be allocated based on the reduced maximum number of objects, the calculation step further comprises:
further reducing at least one of the requests by at least one object and repeating at least part of the calculation step.

19-26. (canceled)

27. One or more non-transitory computer readable media storing computer readable instructions which, when executed, cause a system to perform a method of:
receiving a request from each of the plurality of users, each request comprising one or more parameters;
calculating, based on each of the received requests, an allocated number of the plurality of objects for each user,
wherein the calculation step includes use of an optimisation process to optimise the allocation of the plurality of objects based on the one or more parameters of each request.

28. A system, comprising:
a processor; and
memory storing computer readable instructions which, when executed, cause the system to perform a method of:
receiving a request from each of the plurality of users, each request comprising one or more parameters;
calculating, based on each of the received requests, an allocated number of the plurality of objects for each user,
wherein the calculation step includes use of an optimisation process to optimise the allocation of the plurality of objects based on the one or more parameters of each request.

29. (canceled)
